(19) United States
(12) Patent Application Publication
(10) Pub. No.: US 2018/0308501 A1
(43) Pub. Date: Oct. 25, 2018

(54) MULTI SPEAKER ATTRIBUTION USING PERSONAL GRAMMAR DETECTION

(71) Applicant: aftercode LLC, Minneapolis, MN (US)

(72) Inventors: Marc Everett Johnson, Apple Valley, MN (US); Mitchell Young Coopet, Eden Prarie, MN (US)

(21) Appl. No.: 15/493,948

(22) Filed: Apr. 21, 2017

(51) Int. Cl. G10L 21/028; G10L 17/04; G10L 15/19; G10L 21/10; G10L 17/02; G10L 25/87

(52) U.S. Cl. CPC G10L 21/028; G10L 17/04; G10L 25/87; G10L 21/10; G10L 17/02; G10L 15/19

(57) ABSTRACT

Systems and techniques for multi speaker attribution using personal grammar detection are described herein. A waveform may be obtained including speaking content of a plurality of speakers. The waveform may be separated into a plurality of segments using audio filters. Members of the plurality of segments including non-speaking content may be discarded to create a set of speaker segments. A first speaker segment may be transcribed to generate a first transcript. The first transcript may be evaluated to identify a grammar pattern and a natural language pattern. A speaker profile may be created for a speaker of the plurality of speakers using the grammar pattern. The speaker profile may be attributed to the first speaker segment and the first transcript. The first transcript may be output to a display including an indication of the speaker.

### TECHNICAL FIELD

Embodiments described herein generally relate to speaker attribution and, in some embodiments, more specifically to multi speaker attribution using personal grammar detection.

### BACKGROUND

Several people may speak during a meeting. Audio of the meeting including the speakers' voices may be recorded. Each speaker may have uttered portions of the audio. A person referring to the audio recording may wish to identify portions of the audio recording uttered by each speaker.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for multi speaker attribution using personal grammar detection, according to an embodiment.

FIG. 2 is a block diagram of an example of a multi speaker recognition engine for multi speaker attribution using personal grammar detection, according to an embodiment.

FIG. 3 illustrates an example of a process for multi speaker attribution using personal grammar detection, according to an embodiment.

FIG. 4 illustrates an example of a method for multi speaker attribution using personal grammar detection, according to an embodiment.

FIG. 5 is a block diagram illustrating an example of a machine upon which one or more embodiments may be implemented.

### DETAILED DESCRIPTION

Groups of people may conduct meetings for a variety of reasons such as, for example, to discuss topics, brainstorm, make plans, etc. The group may record audio of the meeting (e.g., using a mobile device, etc.) to maintain a record of the meeting. The record may be accessed to retrieve details that may have been forgotten, to create a summary of the meeting, etc. However, a person accessing the record may need to manually listen to the audio and manually transcribe the audio and/or identify speakers to provide a context for the audio. Manual transcription by humans is prone to errors and omissions because portions of the audio file may be missed or speakers may be misidentified.

Current speaker attribution techniques may rely on spatial analysis of audio collected from multiple microphones. However, these techniques may be ineffective in identifying speakers in a single audio waveform such as, for example, an audio file collected by a single microphone of a mobile device. Other current techniques may identify speakers through analysis of the waveform to identify speakers based on acoustical changes. However, distortion or other inconsistencies in the waveform may reduce the effectiveness of speaker identification leading to errors in speaker identification.

The accuracy of speaker identification may be improved by splitting a single waveform into segments using audio filtering techniques and tokenizing the segments to identify non-speaking portions of the waveform as well as portions of the waveform in which more than one speaker may be speaking. Thus, the waveform may be segmented into segments containing the speech audio for individual speakers. The segments containing individual speaker utterances may be transcribed using speech to text machine learning techniques to obtain text of a speaker's utterance.

The waveform segment and the transcript may be processed using machine learning techniques to generate a confidence score for the text of the utterance as well as an attribution of a speaker to the text. For example, a segment may be processed using an artificial intelligence enhanced transcription algorithm to determine a confidence score for the transcript and the waveform segment may be analyzed using artificial intelligence enhanced voice recognition and the transcript may be analyzed using natural language processing and personal grammar detection to determine an attribution confidence score indicating how likely text in the segment was uttered by a speaker. As each segment of the waveform is analyzed, the machine learning algorithms may identify patterns in the audio of the segments and the text transcripts associated with each segment indicating a speaker that uttered the segment. For example, grammar patterns identified in the transcripts associated with the segments may further indicate that speaker A should be attributed with the text in five of fifteen segments from the waveform.

Increased accuracy in attributing speakers to text transcripts in the segments of the waveform may be increased by applying machine learning techniques to both the audio and text to identify patterns that may be used to calculate confidence scores. Thus, multiple discrete statistical measures may be merged to determine and verify the speaker. Analyzing the audio and text may be completed in parallel which may result in reduced processing times. In addition, because each analysis is discrete, the processing may be distributed across processing units to further increase processing performance.

The techniques described herein may be useful in parallel speech-to-text processing. For example, once the audio has been segmented, the segments may be processed for speech-to-text processing in parallel without breaking words in half (e.g., one process may begin processing whole words rather than waiting for another process to parse individual words, etc.). The parallel processing of the segments may reduce total processing time resulting in faster output delivery. Furthermore, the waveform segments may be used for model isolation, corpora isolation (e.g., separating one corpus of words from another, etc.), and better training. For example, having the text segmented may allow artificial intelligence (AI) training to create custom models per speaker.

The techniques described herein may be used for audio normalization and improvement of the audio waveform. For example, identifying differences between the segments (e.g., a lower volume, etc.) may allow some segments to be treated differently (e.g. the lower volume segments may be normalized/boosted to match the volume level of other segments, etc.).

The techniques described herein may be use for post-processing effects. For example, identifying differences between segments may allow obscuration (e.g., altering tone, frequency, amplitude, etc.) of a voice of a speaker in audio segments attributed to the speaker (e.g., for law enforcement agencies to protect the identity of a witness, etc.) and/or may allow the application of effects (e.g., a pitch changed monster voice) without affecting the other voices in the wafeform.

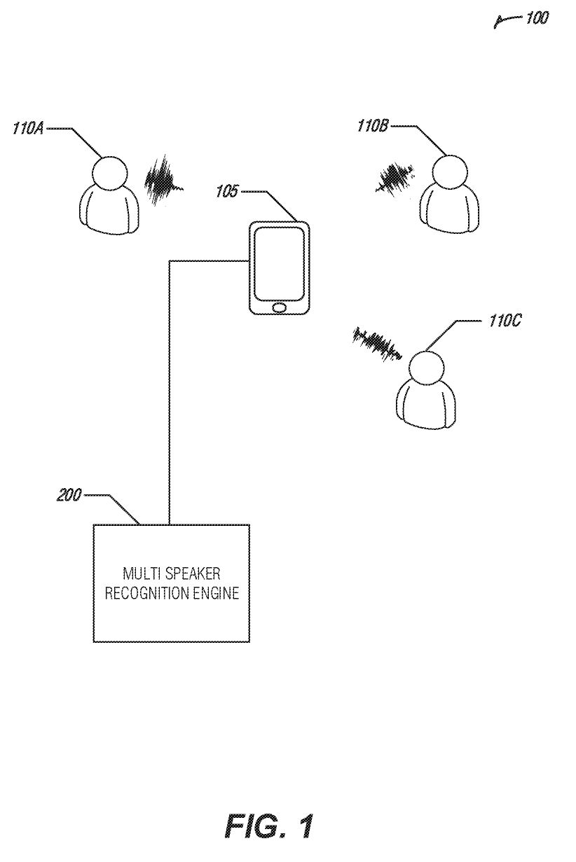

FIG. 1 is a block diagram of an example of an environment 100 including a system 200 for multi speaker attribution using personal grammar detection, according to an embodiment. The environment may include a device 105 (e.g., mobile device, smartphone, tablet, etc.) including a microphone for capturing audio and human speakers 110A, 110B, and 110C. The device 105 may be communicatively coupled, (e.g., via a network, shared bus, etc.) to a multi speaker recognition engine 200. In some examples, the multi speaker recognition engine 200 may be implemented by the device 105 (e.g., as software executing on a processor of the device).

The speakers 110A, 110B, and 110C may be having a conversation. Audio of the conversation may be captured by the microphone and recorded by the device 105. For example, the speakers 110A, 110B, and 110C may be conducting a code review session and the utterances of each of the speakers 110A, 110B, and 110C may be recorded to a single audio file of a smartphone. The audio file may contain a waveform of the utterances, silence, and other audio elements captured by the microphone.

The waveform may be transmitted to the multi speaker recognition engine 200 for processing to identify text of each speaker's utterances and a speaker for each utterance. The multi speaker recognition engine 200 may separate the waveform into segments using blind source separation techniques such as, for example, convolutive non-negative matrix factorization for single channel filtering, algorithm for multiple unknown signals extraction (AMUSE) for multiple channel separation, flexible audio source separation toolbox (FASST) for multiple channel separation, degenerate unmixing estimation technique (DUET) for multiple channel separation, single talker speech enhancement using a microphone array for multiple channel separation, etc. Each segment of the waveform may represent a unique audio element of the waveform such as, for example, an utterance of a speaker, silence, noise, etc. and may represent a token of the tokenized (e.g., separated) waveform.

Each token may be evaluated using overlap, noise and silence detection techniques to adjust the segments based on overlap and/or eliminate segments of noise, silence, other non-utterance audio elements, etc. Segments determined not to contain utterances (e.g., silence, noise, etc.) may be diverted from processing resulting in a potential decrease in processing load. The utterance containing segments may be processed discretely (or as a group) to determine text of utterances contained in each segment and attribute a speaker to the text.

A segment of the waveform may be evaluated using speech to text transcription techniques such as, for example, GOOGLE® Cloud Speech API, MICROSOFT® Bing Speech API. IBM® Watson Speech to Text, APPLE® SiriKit, GOOGLE® android.speech. etc. to generate a text transcript for the segment. For example, a segment may include audio of the phrase “Good morning and welcome to my code review meeting.” and the audio of the segment may be used as input to a text to speech transcription algorithm that in turn outputs a text file containing the recognized text of the utterance. In some examples, the segment may be processed by one or more text to speech algorithms to generate a confidence score for the transcription. For example, a first speech to text algorithm may determine that there is a 0.90 probability that the text output is an accurate representation of the utterance in the segment and a second speech to text algorithm may determine that there is a 0.95 probability that the text output is an accurate representation of the utterance in the segment. In the example, the confidence score may be determined by multiplying the probability of the first speech to text algorithm and the second speech to text algorithm (e.g., 0.90×0.95) to calculate a confidence score of 0.855.

The text transcript for the segment may be evaluated using natural language processing and personal grammar detection techniques such as, for example, Stanford CoreNLP. Natural Language Toolkit (NLTK), Apache OPENNLP®, etc. The natural language processing may include identifying patterns in text of an utterance. For example, the utterance may include several sentences involving a common topic which may be indicative of the speech of a speaker. For example, speaker 110A may have referenced a new software development platform in several sentence of the utterance which may be identified as a pattern indicating that the segment containing the utterance and the corresponding text is attributable to a speaker (e.g., speaker 110A) based on the identified pattern. The output of the natural language processing may be a natural language probability that the text of for the segment of the waveform was uttered by a particular speaker.

The text transcript may be separately evaluated to determine grammar patterns indicative of utterances by a speaker. For example, speaker 110B may have made an utterance containing a particular subject-verb disagreement that may have been repeated in server sentences of the utterance and the pattern of subject-verb disagreements in the text transcript of a segment containing the utterance may be attributed a speaker (e.g., speaker 110B) based on the grammatical pattern of incorrect subject-verb agreement. The output of the personal grammar detection analysis may be a personal grammar detection probability that the text of for the segment of the waveform was uttered by a particular speaker.

The multiple speaker recognition engine 200 may process the audio of the segment using artificial intelligence enhanced voice recognition techniques such as, for example, kaldi automatic speech recognition (ASR) toolkit, end-to-end text-dependent speaker recognition, Microsoft® Speaker Recognition API, etc. The audio for the segment may be evaluated to determine an audio speaker recognition probability that a particular speaker uttered the audio.

The outputs from the natural language processing, personal grammar detection, and the artificial intelligence enhanced voice recognition evaluation may be combined to determine a confidence score indicating the likelihood that the audio segment and corresponding text transcript are attributable to a particular speaker. For example, when the evaluation from the natural language processing, personal grammar detection, and artificial intelligence enhanced voice recognition are combined a confidence score of 0.97 may be calculated (e.g., by averaging probability components, statistical analysis of the results, etc.).

The algorithms used in the natural language processing, personal grammar detection, and voice recognition evaluations and/or the corresponding results of the evaluations may be provided as inputs to a machine learning processor and used as training data that to process additional segments of the waveform and/or segments from other waveforms. For example, speaker 110A may have made utterances in segments 1, 3, and 5 of the waveform and the training data from an evaluation of segment 1 may increase the confidence score identifying a speaker in segment 3 and the training data from an evaluation of segments 1 and 3 may increase the confidence score of an identification of a speaker in segment 5 and so on. In other words, the multi speaker recognition engine 200 may use unsupervised learning techniques to continue improving speaker attribution accuracy as more patterns are recognized in the audio and text of utterance segments. In some examples, users may be asked to confirm or deny that they are the identified speaker. This explicit feedback may also be utilized to refine the models.

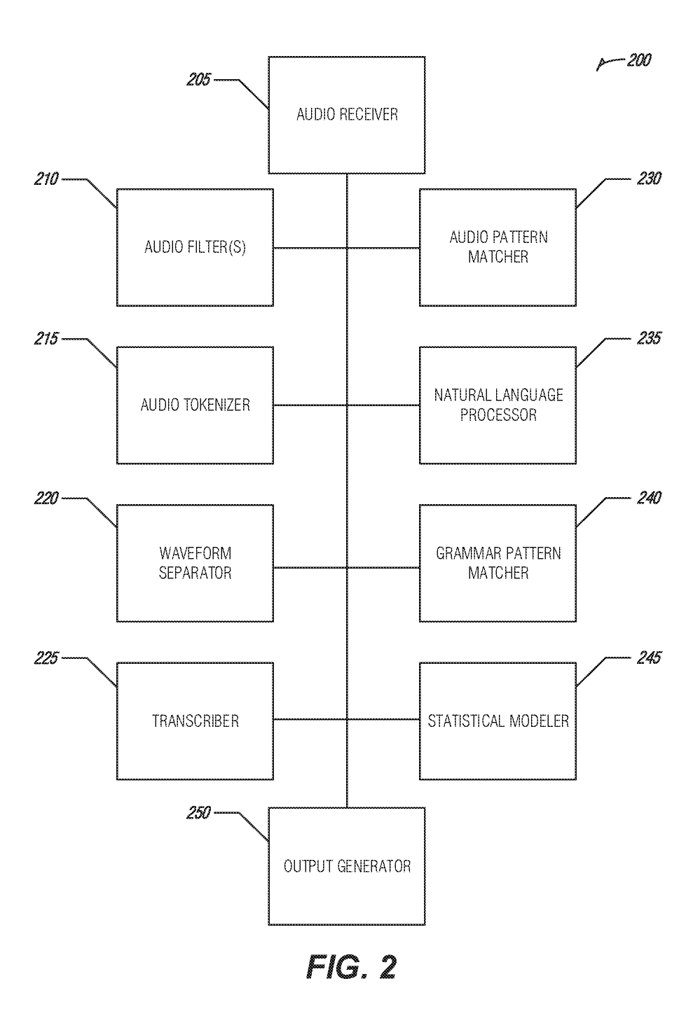

FIG. 2 is a block diagram of an example of a multi speaker recognition engine 200 for multi speaker attribution using personal grammar detection, according to an embodiment. The system 200 may include an audio receiver 205, audio filter(s) 210, audio tokenizer 215, waveform separator 220, transcriber 225, audio pattern matcher 230, natural language processor 235, grammar pattern matcher 240, statistical modeler 245, and output generator 250. The components of the multiple speaker recognition engine 200 may provide features similar to those described in FIG. 1.

The audio receiver 205 may obtain a waveform including speaking content of a plurality of speakers. For example, a group of software developers may be speaking in a code review meeting. In an example, the audio receiver 205 may obtain the waveform from a single microphone. In an example, the microphone may be included in a mobile device (e.g., smartphone, tablet, etc.). For example, a smartphone may include a microphone which may be collecting audio of the software developers speaking in the code review meeting. While examples, provided herein generally describe obtaining a waveform from a single microphone, it may be understood that the techniques described may be equally applicable to waveforms obtained from a variety of microphone configurations. For example with multiple (n) microphones, in addition to increased audio sensitivity, each microphone channel may be processed using the described techniques and compared for consistency and/or selected for highest confidence, to provide more accurate speaker attribution.

The audio filter(s) 210 may detect noise, range, frequency, amplitude time, and other characteristics of the waveform. The audio filter(s) 210 may filter out noise and other non-utterance elements from the waveform to improve later processing of the waveform. The audio filter(s) 210 may preliminarily identify unique segments of the waveform based on characteristics of segments of the waveform. For example, the waveform may contain audio in a first frequency range during the first ten seconds, transition to a audio in a second frequency range for the next thirty seconds, and transition to audio in a third frequency range for a subsequent forty seconds and three segments corresponding to each of the three time periods may be preliminarily identified as unique segments.

The audio tokenizer 215 may detect overlap, silence, and other transitional information in the waveform and preliminarily identified segments of the waveform. For example, a second preliminarily identified segment may contain audio in a frequency range overlapping with a frequency range in a first audio signal because two speakers were making utterances simultaneously. The audio tokenizer 215 may adjust the first preliminarily identified segment to add a portion of the second preliminarily identified segment so that the overlapping utterance is in both segments. During overlapping speaking portions, it may be inferred who is talking based on attribution on either side (e.g., a speaker of a first segment and/or speaker of a second segment, etc.) of the overlap. The audio tokenizer 215 may generate a tokenized waveform with each token representing a unique audio segment determined by the audio filter(s) 210 and the audio tokenizer 215 to contain utterances of speakers included in the waveform.

The waveform separator 220 may separate the waveform into a plurality of segments using inputs received from the audio filter(s) 210 and/or the audio tokenizer 215. In an example, the waveform may be segmented into individual tokens generated by the audio tokenizer 215. For example, the original waveform may have included ten utterances from three speakers and the waveform may be separated into ten segments. In an example, members of the plurality of segments including non-speaking content may be discarded to create a set of speaker segments. For example, the waveform separator 220 may work in conjunction with the audio tokenizer 215 to identify preliminarily identified segments as silence and may remove the segments of silence to prevent the segments from being processed further. The audio filter(s) 210 may use a variety of audio filtering and separation techniques as described in FIG. 1.

The transcriber 225 may transcribe segments of the waveform using a variety of enhanced transcription techniques as described in FIG. 1. The transcriber 225 may process an audio segment to identify letters, numbers, words, phrases, etc. in an audio segment. The transcriber 225 may transcribe a first speaker segment of the set of speaker segments to generate a first transcript. For example, an utterance may include the spoken phrase “the output subroutine” and the transcriber 225 may identify the words “the,” “output,” and “subroutine” in the audio segment and may output the words as text into a transcript of the audio segment. Each audio segment may be processed by the transcriber 225 to generate a corresponding transcript.

The audio pattern matcher 230 may identify patterns in the segmented waveforms. The audio pattern matcher 230 may identify a pattern in audio elements (e.g., frequency changes, oscillation, amplitude, pitch changes, etc.) segments of the waveform and may output an identity of the segments containing the pattern. For example, segments one, three, and five of a ten segment waveform may include a similar speech pattern (e.g., emphasis in an utterance of word, speaking accent, etc.) and segments one, three, and five may be output as including a similar speech pattern. In an example, the first speaker segment of the set of speaker segments may be evaluated to identify a voice pattern corresponding to the first speaker segment. For example, a pattern of an audio frequency and an amplitude may be identified in a segment of the waveform indicating the speaking voice of a particular speaker. The audio pattern matcher 230 may use a variety of speaker recognition techniques to identify patterns in an audio signal as described in FIG. 1.

The natural language processor 235 may analyze the transcript created by the transcriber 225 to identify words, phrases, and other features in the transcript. For example, the natural language processor may use machine learning techniques (linear regression, deep learning, neural networks, etc.) to parse, segment, and classify text. The natural language processor 235 may parse the transcript and identify segments based on a lexicology or other classification scheme. For example, a library of text elements (e.g., words, phrases, etc.) may be associated with a topic and portions of the transcript containing the text elements may be classified as relating to the topic.

The natural language processor 235 may use machine learning techniques to further build the library by using received text input as training data which may be labeled (e.g., manually, automatically, etc.) as being associated with a topic. For example, a user may be presented with a transcript and the user may label portions of the transcript as relating to a topic and the portion of text may be added to the library for use in evaluating future transcripts. In an example, the natural language processor 235 may evaluate the first transcript to identify a natural language pattern. For example, a transcript for an audio segment of the waveform may include text reciting “code review for project Aquarius” and “output subroutine for project Aquarius” and the portions of the transcript may be indicated as being related to the topic “project Aquarius” based on the word Aquarius being in a library associated with the topic project Aquarius. The natural language processor 235 may provide output including, by way of example and not limitation, the topic, a number of times a topic was identified in the transcript, locations of the topic in the transcript, etc.

The grammar pattern matcher 240 may identify patterns in the transcript created by the transcriber 225. The grammar pattern matcher 240 may identify particularities in the grammatical style of a speaker. For example, a speaker may use particular idioms and colloquialisms that may be present in the transcript. The grammar pattern matcher 240 may evaluate the first transcript to identify a grammar pattern. For example, the transcript may contain several instances of the phrase “fish in a barrel” and the phrase “fish in a barrel” may be identified as a grammar pattern in the transcript. The identified grammar patterns may be used to generate a speaker profile for a user. In an example, a transcript for each segment of the waveform may be evaluated and the grammar patterns may be identified across the transcripts. The grammar pattern matcher 240 may output, by way of example and not limitation, the grammar pattern element (e.g., the matched text, etc.), a number of times a grammar pattern element was identified in a transcript and/or set of transcripts, the location of each grammar pattern element.

The statistical modeler 245 may generate statistical models such as speaker profiles that may be used to classify transcripts, waveform segments, and the like. The statistical modeler 245 may use outputs from the transcriber 225, the audio pattern matcher 230, the natural language processor 235, and the grammar pattern matcher 240 as inputs. The statistical modeler 245 may create a speaker profile for a speaker of the plurality of speakers using the grammar pattern identified by the grammar pattern matcher 240. In an example, the speaker profile may be created using the voice pattern output by the audio pattern matcher 230. In an example, the speaker profile may be created using the natural language pattern output by the natural language processor 235.

The statistical modeler 245 may work in conjunction with the transcriber 225 to evaluate text of the transcript to determine a confidence score for the accuracy of portions of text in the transcript. For example, the a segment of the waveform may include a portion transcribed as “sixty times” which the transcriber may have selected over “six tee times” and the statistical modeler 245 may receive statistical data from the transcriber 225 indicating probabilities for potential phrase variations, number of possible phrase selections, etc. and the statistical data may be used to determine the confidence score. For example, the transcriber 225 may output that there were two phrase possibilities with the selected text being the correct 93% of the time, the unselected text being correct 5% of the time, and a 2% chance the phrase is unknown for the audio portions similar to the audio portion analyzed and the confidence score may be 0.93 for the portion of transcribed text.

The statistical modeler 245 may use outputs from the audio pattern matcher 230, the natural language processor 235, and the grammar pattern matcher 240 to calculate a confidence score indicating the probability that the portion of text is attributable to a speaker. In an example, the outputs may be compared to the speaker models to identify a speaker (e.g., based on confidence score, etc.) For example, the output from the audio pattern matcher 230 may indicate there is a 0.92 probability that the portion of the transcript is attributable to speaker A and a 0.08 that the portion of the transcript is attributable to speaker B. The output from the natural language processor 235 may indicate that there is a 0.9 probability that the transcript is attributable to speaker A. The statistical modeler 245 may make the determination based on the speaker profile for speaker A including frequent discussion of the topic “project Aquarius” which may have been identified in the portion of the transcript. Continuing with the example, the output from the grammar pattern matcher 240 may indicate there is a 0.95 probability that the portion of the transcript is attributable to speaker A because the speaker profile for speaker A and the portion of the transcript both indicate a pattern of using the euphemism “doggone.” The statistical modeler 245 may use the individual probabilities to generate a confidence score of 0.92 that the portion of text is attributable to speaker A. In some examples, a set of weights may be applied to each of the confidence scores that reflects a learned importance of each of the outputs. These weights may be provided by an administrator or may be learned by supervised machine learning (e.g., using a regression model).

In an example, a second speaker segment of the set of speaker segments may be transcribed to generate a second transcript. The second speaker segment and the second transcript may be analyzed using the speaker profile to calculate a confidence score. The second speaker segment and the second transcript may be attributed to the speaker based on the confidence score and the second transcript including an indication of the speaker may be output for display on the display device. For example, the statistical modeler 245 may compare the output received from the audio pattern matcher 230, the natural language processor 235, and the grammar pattern matcher 240 to the speaker profile to attribute subsequent waveform segments and corresponding transcripts to the speaker. The statistical modeler 245 may use machine learning techniques to further refine the speaker profile using results of the comparison.

In an example, the statistical modeler 245 may obtain a set of historical speaker segments and a set of historical transcripts and may generate a profile model for the speaker using the set of historical speaker segments and the set of historical transcripts. For example, audio segments and transcripts previously analyzed and attributed to the speaker may be evaluated to generate the profile model for the speaker. The historical audio segments and transcripts may indicate grammar patterns, voice patterns, topic preferences, and other information that may be used to attribute current and/or future audio segments and/or transcripts to the speaker. In an example, creating the speaker profile may include using the profile model for the speaker. For example, output generated for a presently analyzed audio segment and/or transcript may be combined with the profile model to generate a present speaker model for attributing the present audio segment and/or transcript to the speaker.

The output generator 250 may generate output for display on a display device. The output generator 250 may generate output including, by way of example and not limitation, the transcripts, attributed speakers, confidence scores, etc. The output may be generated for output to a display device (e.g., a screen, etc.). In an example, the output may be generated for output on a screen of a mobile device. In an example, the first transcript including an indication of the speaker may be output for display on a display device.

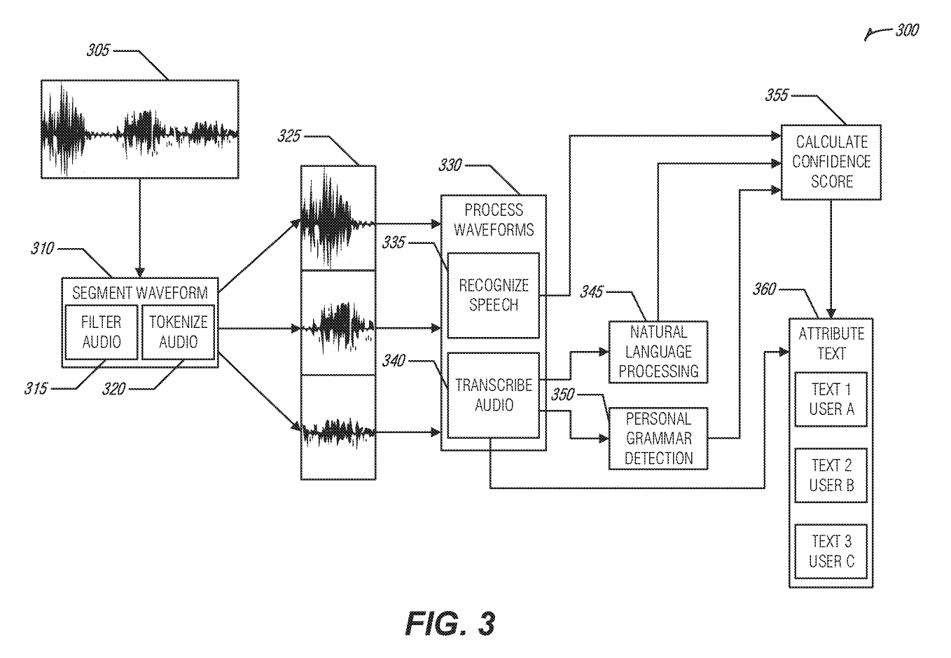

FIG. 3 illustrates an example of a process 300 for multi speaker attribution using personal grammar detection, according to an embodiment. The process 300 may provide the features as described in FIGS. 1 and 2.

At operation 305, a waveform may be obtained (e.g., via the audio receiver 205 as described in FIG. 2 from a microphone in a mobile device, etc.).

At operation 310, the waveform may be segmented by filtering the audio at operation 315 and tokenizing the audio at operation 320 (e.g., using the audio filter(s) 210 and audio tokenizer 215 as described in FIG. 2). For example, the waveform may be divided into multiple unique segments including utterances of one or more speakers.

At operation 325, the segmented waveform may be forwarded for processing (e.g., using the waveform separator 220 as described in FIG. 2).

At operation 330, the waveform may be processed by recognizing speech at operation 335 and transcribing audio to generate a transcript at operation 340 (e.g., using the transcriber 225 as described in FIG. 2). The recognized speech may continue processing at operation 355 and the transcript may continue processing at operations 345 and 350.

At operation 345, the transcript may be processed using natural language processing to identify topics and other features of the transcript (e.g., using the natural language processor 235 as described in FIG. 2).

At operation 350, the transcript may be processed using personal grammar detection to determine grammar particularities in the transcript (e.g., using the grammar pattern matcher 240 as described in FIG. and 2).

At operation 355, confidence scores may be calculated (e.g., by the statistical modeler 245 as described in FIG. 2). For example, a first confidence score may be calculated for the transcript indicating a confidence that the transcript accurately reflects the utterances in the corresponding waveform segment and a second confidence score may be calculated for a speaker-transcript element combination indicating the confidence that the speaker made the utterance in the segment of the waveform represented in the transcript.

At operation 360, the text of the transcript may be attributed (e.g., using the statistical modeler 245 and the output generator 250 as described in FIG. 2). For example, attributions may be made for each transcript element of the transcript (e.g., based on the confidence score for the speaker-transcript element, etc.). The text of the transcript and the corresponding attributions may be output for display on a display device (e.g., using the output generator 250 as described in FIG. 2). Note that the operations of FIG. 3 may be repeated for one, more than one, or all of the segments.

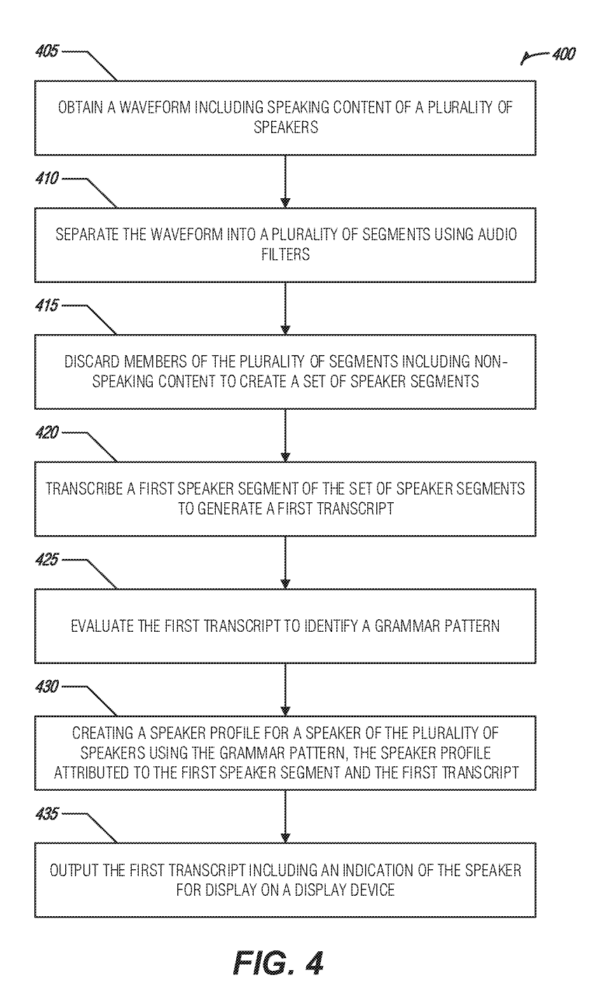

FIG. 4 illustrates an example of a method 400 for multi speaker attribution using personal grammar detection, according to an embodiment. The method 400 may provide functionality as described in FIGS. 1, 2, and 3.

At operation 405, a waveform may be obtained including speaking content of a plurality of speakers. In an example, the waveform may be obtained from a single microphone. In an example, the single microphone may be included with a mobile device.

At operation 410, the waveform may be separated into a plurality of segments using audio filters.

At operation 415, members of the plurality of segments including non-speaking content may be discarded to create a set of speaker segments.

At operation 420, a first speaker segment of the set of speaker segments may be transcribed to generate a first transcript.

At operation 425, the first transcript may be evaluated to identify a grammar pattern

At operation 430, a speaker profile may be created for a speaker of the plurality of speakers using the grammar pattern. The speaker profile may be attributed to the first speaker segment and the first transcript. In an example, the first speaker segment of the set of speaker segments may be evaluated to identify a voice pattern corresponding to the first speaker segment and the creation of the speaker profile may include using the voice pattern. In an example, the first transcript may be evaluated to identify a natural language pattern and the creation of the speaker profile may include using the natural language pattern.

In an example, a set of historical speaker segments and a set of historical transcripts may be obtained and a profile model may be generated for the speaker using the set of historical speaker segments and the set of historical transcripts. In the example, the creation of the speaker profile may include using the profile model for the speaker.

At operation 435, the first transcript including an indication of the speaker may be output for display on a display device.

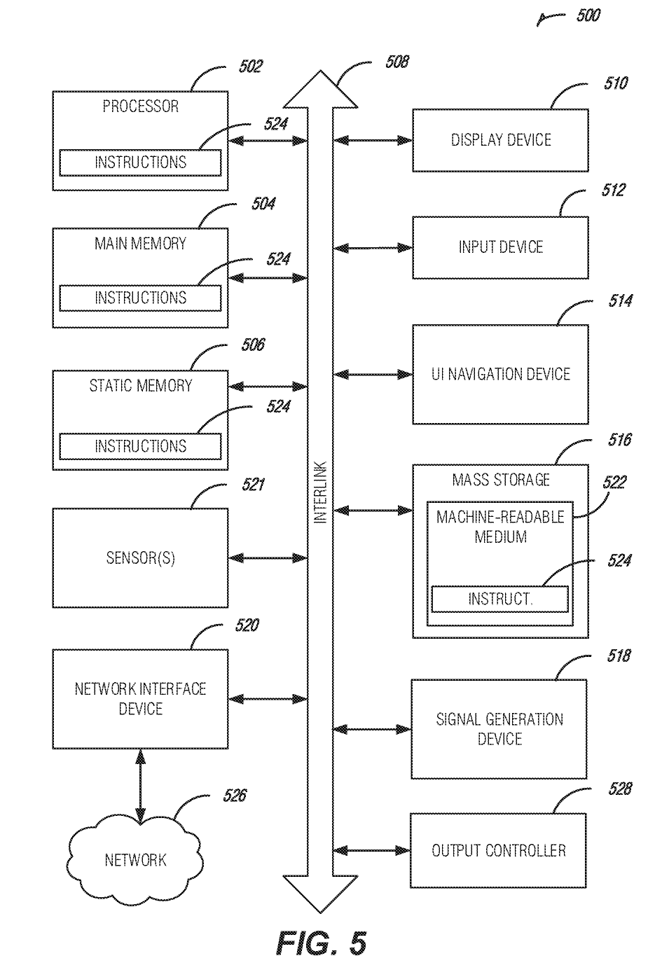

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a computing device (such as device 105), a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. The machine 500 may implement the multi speaker recognition engine 200, including the components of FIG. 2, and FIG. 3, as well as the methods of FIG. 4. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks). Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### ADDITIONAL NOTES

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first.” “second,” and “third.” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for attributing a portion of a waveform to a speaker, the system comprising:
at least one processor; and
machine readable media including instructions that, when executed by the at least one processor, cause the at least one processor to:
obtain a waveform including speaking content of a plurality of speakers;
separate the waveform into a plurality of segments using audio filters;
discard members of the plurality of segments including non-speaking content to create a set of speaker segments;
transcribe a first speaker segment of the set of speaker segments to generate a first transcript;
evaluate the first transcript to identify a grammar pattern;
create a speaker profile for a speaker of the plurality of speakers using the grammar pattern, the speaker profile attributed to the first speaker segment and the first transcript; and
output, for display on a display device, the first transcript including an indication of the speaker.

2. The system of claim 1, wherein the instructions to create the speaker profile includes instructions to:
evaluating the first speaker segment of the set of speaker segments to identify a voice pattern corresponding to the first speaker segment, wherein creating the speaker profile includes using the voice pattern.

3. The system of claim 1, wherein the instructions to create the speaker profile includes instructions to:
evaluate the first transcript to identify a natural language pattern, wherein creating the speaker profile includes using the natural language pattern.

4. The system of claim 1, further comprising instructions to:
transcribing a second speaker segment of the set of speaker segments to generate a second transcript;
analyzing the second speaker segment and the second transcript using the speaker profile to calculate a confidence score;
attributing the second speaker segment and the second transcript to the speaker based on the confidence score; and
outputting, for display on a display device, the second transcript including an indication of the speaker.

5. The system of claim 1, further comprising instructions to:
obtaining a set of historical speaker segments and a set of historical transcripts; and
generating a profile model for the speaker using the set of historical speaker segments and the set of historical transcripts, wherein creating the speaker profile includes using the profile model for the speaker.

6. The system of claim 1, wherein the waveform is obtained from a single microphone.

7. The system of claim 6, wherein the single microphone is included with a mobile device.

8. At least one machine readable medium including instructions for attributing a portion of a waveform to a speaker that, when executed by a machine, cause the machine to:
obtain a waveform including speaking content of a plurality of speakers;
separate the waveform into a plurality of segments using audio filters;
discard members of the plurality of segments including non-speaking content to create a set of speaker segments;
transcribe a first speaker segment of the set of speaker segments to generate a first transcript;
evaluate the first transcript to identify a grammar pattern;
create a speaker profile for a speaker of the plurality of speakers using the grammar pattern, the speaker profile attributed to the first speaker segment and the first transcript; and
output, for display on a display device, the first transcript including an indication of the speaker.

9. The at least one machine readable medium of claim 8, wherein the instructions to create the speaker profile includes instructions to:
evaluating the first speaker segment of the set of speaker segments to identify a voice pattern corresponding to the first speaker segment, wherein creating the speaker profile includes using the voice pattern.

10. The at least one machine readable medium of claim 8, wherein the instructions to create the speaker profile includes instructions to:
evaluate the first transcript to identify a natural language pattern, wherein creating the speaker profile includes using the natural language pattern.

11. The at least one machine readable medium of claim 8, further comprising instructions to:
transcribing a second speaker segment of the set of speaker segments to generate a second transcript;
analyzing the second speaker segment and the second transcript using the speaker profile to calculate a confidence score;
attributing the second speaker segment and the second transcript to the speaker based on the confidence score; and
outputting, for display on a display device, the second transcript including an indication of the speaker.

12. The at least one machine readable medium of claim 8, further comprising instructions to:
obtaining a set of historical speaker segments and a set of historical transcripts; and
generating a profile model for the speaker using the set of historical speaker segments and the set of historical transcripts, wherein creating the speaker profile includes using the profile model for the speaker.

13. The at least one machine readable medium of claim 8, wherein the waveform is obtained from a single microphone.

14. The at least one machine readable medium of claim 13, wherein the single microphone is included with a mobile device.

15. A method for attributing a portion of a waveform to a speaker, the method comprising:
obtaining a waveform including speaking content of a plurality of speakers;
separating the waveform into a plurality of segments using audio filters;
discarding members of the plurality of segments including non-speaking content to create a set of speaker segments;
transcribing a first speaker segment of the set of speaker segments to generate a first transcript;
evaluating the first transcript to identify a grammar pattern;
creating a speaker profile for a speaker of the plurality of speakers using the grammar pattern, the speaker profile attributed to the first speaker segment and the first transcript; and
outputting, for display on a display device, the first transcript including an indication of the speaker.

16. The method of claim 15, wherein creating the speaker profile includes:
evaluating the first speaker segment of the set of speaker segments to identify a voice pattern corresponding to the first speaker segment, wherein creating the speaker profile includes using the voice pattern.

17. The method of claim 15, wherein creating the speaker profile includes:
evaluating the first transcript to identify a natural language pattern, wherein creating the speaker profile includes using the natural language pattern.

18. The method of claim 15, further comprising:
transcribing a second speaker segment of the set of speaker segments to generate a second transcript;
analyzing the second speaker segment and the second transcript using the speaker profile to calculate a confidence score;
attributing the second speaker segment and the second transcript to the speaker based on the confidence score; and
outputting, for display on a display device, the second transcript including an indication of the speaker.

19. The method of claim 15, further comprising:
obtaining a set of historical speaker segments and a set of historical transcripts; and
generating a profile model for the speaker using the set of historical speaker segments and the set of historical transcripts, wherein creating the speaker profile includes using the profile model for the speaker.

20. The method of claim 15, wherein the waveform is obtained from a single microphone.

21. The method of claim 20, wherein the single microphone is included with a mobile device.
